(19) United States
(12) Patent Application Publication
(10) Pub. No.: US 2021/0389966 A1
(43) Pub. Date: Dec. 16, 2021

(54) MICRO KERNEL BASED EXTENSIBLE HYPERVISOR AND EMBEDDED SYSTEM

(71) Applicant: Samsung Electronics Co., Ltd., Suwon-si (KR)

(72) Inventors: Lei WANG, Xian (CN); Gang LI, Xian (CN); Yuehua DAI, Xian (CN); Mindong ZHAO, Xian (CN); Shuang ZHAO, Xian (CN)

(73) Assignee: Samsung Electronics Co., Ltd., Suwon-si (KR)

(21) Appl. No.: 17/179,814

(22) Filed: Feb. 19, 2021

(30) Foreign Application Priority Data
Jun. 12, 2020 (CN) 2020 1 0533671.X

(51) Int. Cl. G06F 9/455

(52) U.S. Cl. CPC G06F 9/45558; G06F 2009/45591; G06F 2009/4557

(57) ABSTRACT

At least one example embodiment of the inventive concepts include an embedded system including processing circuitry configured to execute an extensible hypervisor, the extensible hypervisor including a micro kernel and a virtualization service layer, the micro kernel is configured to provide a virtualization environment for at least one first-type virtual machine, the virtualization service layer is configured to provide a service interface for at least one second-type virtual machine, and the micro kernel is executed at a first privilege layer, and the virtualization service layer is executed at a second privilege layer.

### CROSS-REFERENCE TO RELATED APPLICATION

This U.S. non-provisional application claims the benefit of priority under 35 U.S.C. § 119 to Chinese Patent Application No. 202010533671.X, filed on Jun. 12, 2020 in the China National Intellectual Property Administration (CNIPA), the contents of which are herein incorporated by reference in their entirety.

### BACKGROUND

Various example embodiments of the inventive concepts relate to a system software field, and more specifically, to a non-transitory computer readable medium including a micro kernel based extensible hypervisor, a method of operating the micro kernel based extensible hypervisor, a computing device for operating the micro kernel based extensible hypervisor, and/or an embedded system thereof.

With the continued development of the system software industry, it is desired and/or necessary to provide a safe and reliable service on a hardware platform, as well as extensibility to meet a user requirement. Therefore, more and more embedded systems have introduced and/or included virtualization technology.

However, current virtualization technology is incomplete. For example, the current virtualization technology relates to usage of a hypervisor. Such hypervisors includes: XEN Hypervisor, Wind River, QNX, Mentor, etc. However, the existing hypervisors do not and/or cannot effectively manage safety-critical service and non-safety-critical service, and have poor extensibility. That is, existing hypervisor have deficiencies in terms of safety and/or extensibility.

### SUMMARY

Various example embodiments of the inventive concepts provide a hypervisor that may ensure stability and safety, while also having extensibility to support non-critical and/or safety related functionality.

According to at least one example embodiment, a system-on-chip (SOC) configured to execute an extensible hypervisor is provided. The SOC may include: processing circuitry configured to execute the extensible hypervisor, the extensible hypervisor including a micro kernel and a virtualization service layer; the micro kernel is configured to provide a virtualization environment for at least one first-type virtual machine; the virtualization service layer is configured to provide a service interface for at least one second-type virtual machine; and the micro kernel is executed at a first privilege layer, and the virtualization service layer is executed at a second privilege layer. The extensible hypervisor of at least one example embodiment of the inventive concepts may separate the safety virtual machine (e.g., safe virtual machine, critical virtual machine, essential virtual machine, etc.) from the unsafety virtual machine (e.g., unsafe virtual machine, non-critical virtual machine, non-essential virtual machine, etc.) through the micro kernel and the virtualization service layer, and the micro kernel and the virtualization service layer running in different privilege levels do not interfere with each other, so that an embedded system and/or service can run stably and/or safely.

Additionally, according to at least one example embodiment, the micro kernel is further configured to perform at least one of: perform static assignment of at least one processor resource and/or at least one memory resource for the at least one first-type virtual machine; provide a communication channel for the at least one first-type virtual machine; and manage the virtualization service layer; and communicate with at least one of the at least one first-type virtual machine, the at least one second-type virtual machine, and the virtualization service layer. The static assignment of the resource through the micro kernel can increase and/or ensure normal operation of the safety virtual machine, and providing a communication function by the micro kernel may embody effective interaction between components of the hypervisor.

Additionally, according to at least one example embodiment, the managing of the virtualization service layer includes: monitoring the virtualization service layer, and wherein the monitoring includes: creating a virtual machine instance, destroying the virtual machine instance, or resetting the virtual machine instance. By monitoring the virtualization service layer, it is possible to manage the virtualization service layer more flexibly and/or effectively.

Additionally, according to at least one example embodiment, the communicating with the at least one first-type virtual machine includes: performing information forwarding among a plurality of first-type virtual machines. Through the information forwarding, communication can be increased and/or ensured to be smoothly performed.

Additionally, according to at least one example embodiment, the micro kernel and the at least one first-type virtual machine and/or the at least one second-type virtual machine perform the communicating through a trap, and the micro kernel and the virtualization service layer perform the communicating through a system call and the trap. Communication is performed through the system call and the trap, which can increase and/or ensure the interaction and/or safety of the interaction.

Additionally, according to at least one example embodiment, the virtualization service layer is further configured to control at least one of: performing a dynamic scheduling of at least one processor resource and/or at least one memory resource for the at least one second-type virtual machine; monitoring the at least one second-type virtual machine, wherein the monitoring comprises creating a second-type virtual machine instance, destroying the second-type virtual machine instance, or resetting the second-type virtual machine instance; performing information forwarding among a plurality of second-type virtual machines; and providing a device virtualization service to implement device sharing for the plurality of second-type virtual machines. The virtualization service layer implements more flexible and/or effective control operations through the above contents, and increases and/or guarantees smooth implementation of functionality of the unsafety virtual machine.

Additionally, according to at least one example embodiment, the virtualization service layer is further configured to implement controlling of the at least one second-type virtual machine using a trap and a system call between the virtualization service layer and the micro kernel, and the trap between the micro kernel and the at least one second-type virtual machine. The virtualization service layer may implement the control of the unsafety virtual machine with the cooperation of the micro kernel. That is, the micro kernel improves, increases and/or guarantees the virtualization service layer controls the unsafety virtual machine.

According to at least one example embodiment, an embedded system is provided, and the embedded system includes: a memory configured to store computer readable instructions; and processing circuitry configured to execute the computer readable instructions to implement an extensible hypervisor, the extensible hypervisor including a micro kernel and a virtualization service layer, wherein the micro kernel is configured to provide a virtualization environment for at least one first-type virtual machine, the virtualization service layer is configured to provide a service interface for at least one second-type virtual machine, and the micro kernel is executed at a first privilege layer, and the virtualization service layer is executed at a second privilege layer.

According to at least one example embodiment, there is provided a non-transitory computer-readable storage medium storing computer-readable instructions, wherein when the computer-readable instructions is executed by processing circuitry, the processing circuitry is caused to, execute an extensible hypervisor, the extensible hypervisor including a micro kernel and a virtualization service layer, the micro kernel being configured to provide a virtualization environment for at least one first-type virtual machine, the virtualization service layer being configured to provide a service interface for at least one second-type virtual machine, and the micro kernel is executed at a first privilege layer, and the virtualization service layer is executed at a second privilege layer.

In summary, according to some example embodiments of the extensible hypervisor and the embedded system of the inventive concepts, a virtualization environment may be provided for the safety virtual machine through the micro kernel, and the service interface can be provided for the unsafety virtual machine through the virtualization service layer, thereby operation, execution, and/or running of the safety virtual machine and operation, execution, and/or running of the unsafety virtual machine do not interfere with each other. The micro kernel for the safety virtual machine and the virtualization service layer for the unsafety virtual machine run in different privilege levels, which can ensure that even if the unsafety virtual machine fails (e.g., crashes, encounters an error, stops operating, etc.), it will not affect operation of the safety virtual machine. Therefore, the stable and/or safe operation of the safety virtual machine can be improved, increased, and/or guaranteed. Additionally, the unsafety virtual machine may provide the service interface to support an extended service (for example, a communication service, a resource sharing service, and/or other optional functionality, etc.), the hypervisor also has extensibility. When running a safety-critical service on the safety virtual machine and a non-safety-critical service on the unsafety virtual machine, the safe and stable operation of the safety-critical service can be increased, improved, and/or guaranteed.

Additional aspects and/or advantages of the example embodiments of the inventive concepts will be explained in the following description, and still others will be clear from the description, or may be known through the implementation of the inventive concepts.

### BRIEF DESCRIPTION OF THE DRAWINGS

The above and other objects, features and advantages of the inventive concepts will become more clear through the following detailed description in conjunction with the drawings, wherein

FIG. 1 shows a schematic structural diagram of an extensible hypervisor according to at least one example embodiment;

FIG. 2 shows a schematic diagram of interaction of an extensible hypervisor according to at least one example embodiment; and

FIG. 3 shows a block diagram of an embedded system according to at least one example embodiment.

### DETAILED DESCRIPTION

Various example embodiments of the inventive concepts are described in detail below with reference to the drawings.

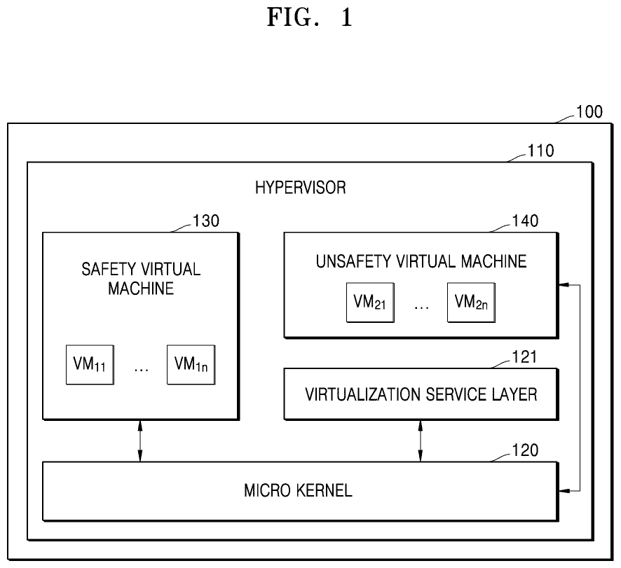

FIG. 1 shows a schematic structural diagram of an extensible hypervisor according to at least one example embodiment of the inventive concepts.

In at least one example embodiment of the inventive concepts, a hypervisor 110 may be provided in an embedded system 100, and the embedded system may be implemented as a system on chip (SoC) (not shown) such as an ARM system, and the like, but the example embodiments are not limited thereto and, for example, the example embodiments may include other chipsets, such as MIPS, PowerPC, x86 systems, other RISC and/or CISC systems, etc. Additionally, according to some example embodiments, the embedded system 100 may be any processing circuitry capable of performing the functionality of the hypervisor 110, etc. The processing circuitry may include hardware, such as processors, processor cores, logic circuits, etc.; a hardware/software combination such as at least one processor core executing software and/or executing any instruction set, etc.; or a combination thereof. For example, the processing circuitry more specifically may include, but is not limited to, a field programmable gate array (FPGA), a programmable logic unit, an application-specific integrated circuit (ASIC), a digital signal processor (DSP), a microcontroller, a SoC, etc.

According to at least one example embodiment, the hypervisor 110 may include a micro kernel 120 of an operating system (e.g., an embedded operating system, etc.) and/or the virtualization service layer 121, etc., but is not limited thereto. According to at least one example embodiment, the micro kernel 120 may provide the virtualization environment for a first-type of virtual machine, such as a safety (e.g., safe and/or secure) virtual machine 130 (e.g., at least one virtual machine configured to execute safety-related functionality of the embedded system 100, execute critical and/or necessary functionality of the embedded system 100, execute high-priority functionality of the embedded system 100, etc.), but the example embodiments are not limited thereto. According to at least one example embodiment, the virtualization service layer 121 provides the service interface for a second-type of virtual machine, such as an unsafety (e.g., unsafe and/or unsecure) virtual machine 140 (e.g., at least one virtual machine configured to execute nonsafety-related functionality of the embedded system 100, execute non-critical and/or optional functionality of the embedded system 100, execute low-priority functionality of the embedded system 100, etc.), and the unsafety virtual machine 140 supports an extended service, etc. However, the example embodiments are not limited thereto, and for example, a greater or lesser number of constituent elements may be included in the hypervisor of the example embodiments. Additionally, the extended service may be a service that supports communication with devices (such as, an electronic device, etc.), a service that shares at least one resource (e.g., a hardware resource, such as memory, a communication bus, etc., and/or a software resource, such as a mutex, a lock, etc.) between the devices and the like, but the example embodiments are not limited thereto. At the same time, the micro kernel 120 and the virtualization service layer 121 may run in different privilege levels associated with an operating system executed by the embedded system, so that the running (e.g., execution, operation, etc.) of the micro kernel 120 and the running of the virtualization service layer 121 do not affect each other, and the stability and/or operational safety of the micro kernel 120 is increased, improved, and/or guaranteed, wherein the security virtual machine (e.g., first-type virtual machine, etc.) corresponds to the micro kernel 120 (e.g., the security virtual machine executes at the same privilege level as the micro kernel, etc.), but the example embodiments are not limited thereto.

In at least one example embodiment of the inventive concepts, the safety-critical service may include a service related to the operation of an external device that the embedded system 100 is implemented and/or included within, such as control of a motor vehicle, an aircraft, a spacecraft, a naval vessel, control of a robotic system, etc., (e.g., an automatic driving operation, braking operation, throttle control operation, steering, and the like), which includes the embedded system 100, but the example embodiments are not limited thereto. A non-safety-critical service may include a service related to the operation of non-safety-critical services, such as music playback, video playback, passenger comfort features, etc., of the object that the embedded system 100 is included within. However, the example embodiments are not limited thereto, and it is feasible to distinguish the safety-critical (e.g., higher priority) service from the non-safety-critical (e.g., lower priority) service by other division methods, including based on user inputs (e.g., user configuration), etc.

Referring again to FIG. 1, according to at least one example embodiment, the hypervisor 100 may include: a micro kernel 120 configured to provide a virtualization environment for a plurality of safety virtual machines 130 (e.g., VM₁₁ to VM₁ₙ), wherein each of the safety virtual machines 130 may execute one or more safety critical services and/or operations; and a virtualization service layer 121 configured to provide a service interface (not shown) for managing a plurality of unsafety virtual machines 140 (e.g., VM₂₁ to VM₂ₙ), wherein each of the unsafety virtual machines 140 may execute one or more non-safety-critical services and/or operations, wherein the micro kernel 120 and the virtualization service layer 121 run in different privilege levels, and the unsafety virtual machine 140 that provides the service interface which supports the extended service.

As an example, the unsafety virtual machine 140 supporting the extended service means that the unsafety virtual machine 140 may have extension capability. Therefore, the hypervisor 110 of at least one example embodiment may be referred to as an extensible hypervisor. The extension capability (e.g., extensible hypervisor) may include the capability of providing communication services, the capability of providing resource sharing, and/or any other capabilities and/or services that are not related, not desired, not critical, and/or not necessary to safety functionality of the embedded system, or the like. The extension capability may be implemented through a service interface (not shown) of the virtualization service layer 121. The extension capability of the unsafety virtual machine 140 may also be embodied in providing support for one or more operating systems (such as, a Linux operating system, an Android operating system, an embedded Unix operating system, etc.), and the unsafety virtual machine 140 may have better compatibility than the safety virtual machine 130.

As an example, the safety virtual machine 130 may support one or more safety-critical services, so the safety virtual machine 130 may provide the virtualization environment for the one or more safety-critical services. The unsafety virtual machine 140 may support one or more non-safety-critical services, so the unsafety virtual machine 140 provides the virtualization environment for the one or more non-safety-critical services. The micro kernel 120 and virtualization service layer 121 can be understood as a unit, component, and/or element of the hypervisor 110, but is not limited thereto. For example, the hypervisor 110, micro kernel 120, and the virtualization service layer 121 may all be executed on the same processing circuitry, the same processor, the same processor core, etc., or one or more of the hypervisor 110, micro kernel 120, and/or the virtualization service layer 121 may execute on different processing circuitries, different processors, different processor cores, etc., or any combinations thereof. According to at least one example embodiment, the hypervisor 110 respectively manages the safety virtual machine 130 and the unsafety virtual machine 140 through different units (e.g., components and/or elements, etc.), and the different units may run (e.g., operate and/or execute) in different privilege levels. Since an error of the unit running in one privilege level does not affect the running of the unit running in another privilege level, the influence between the micro kernel 120 and the virtualization service layer 121 may be reduced to increase, improve, and/or ensure the stability of the safety virtual machine 130 or even the hypervisor 110. According to at least one example embodiment, the privilege level of the micro kernel 120 may be higher than the privilege layer of the virtualization service layer 121, but the example embodiments are not limited thereto.

With respect to the safety virtual machine 130 (e.g., the first-type virtual machine, etc.), the micro kernel 120 may also be configured to perform at least one of: performing static assignment of at least one processor resource and/or at least one memory resource for the safety virtual machine 130; providing at least one communication channel for the safety virtual machine 130; managing the virtualization service layer 121; and communicating with at least one of the safety virtual machine 130, the unsafety virtual machine 140, and/or the virtualization service layer 121, or any combinations thereof, but the example embodiments are not limited thereto and may include other operations.

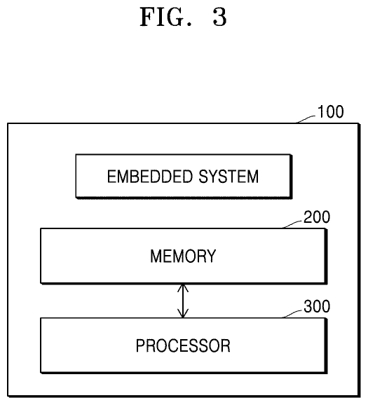

Referring now to FIG. 3, according to at least one example embodiment, the processor resource may be represented by the capability of using at least one processor 300 (and/or processor core, etc.) of the embedded system 100, and the memory resource may be represented by the capability of using a memory 200 (such as, RAM, a physical memory device (e.g., SSD, hard drive, etc.), etc.), however the example embodiments are not limited thereto, and additional resources may be included and/or available to the embedded system 100, such as network resources, sensors, input/output devices (e.g., display devices, speakers, keyboard, microphone, camera, touchscreen panels, etc.), control components (e.g., steering controls, antennas, motor/engine/propulsion controls, etc.). The static assignment may mean that the processor resource and/or the memory resource are not changed for a desired period of time after being assigned, but is not limited thereto. The processor here may represent a central processing unit (CPU), a graphics processing unit (GPU), a digital signal processor (DSP), etc., but the example embodiments are not limited thereto. FIG. 3 will be discussed in further detail below.

Referring again to FIG. 1, according to some example embodiments, the operation for managing the virtualization service layer 121 by the hypervisor 110 and/or micro kernel 120 may include: monitoring the virtualization service layer, the monitoring including: creating, destroying or resetting a virtualization service layer and/or a virtual machine instance, etc., but the example embodiments are not limited thereto. Accordingly, the micro kernel 120 is a core of the hypervisor 110, but is not limited thereto.

As an example, the operation of communicating with the safety virtual machine 130 by the hypervisor 110 and/or micro kernel 120 may include: performing information retransmission among a plurality of safety virtual machines, but is not limited thereto. Through the communication, simple, desired, and/or necessary information may be transferred among the plurality of safety virtual machines, etc. The device virtualized by the security virtual machine may be enforced to be in a pass-through mode, but the example embodiments are not limited thereto.

With respect to the unsafety virtual machine 140 (e.g., second-type virtual machine, etc.), the virtualization service layer 121 is further configured to control at least one of the following operations: performing a dynamic scheduling of at least one processor resource and/or at least one memory resource of the unsafety virtual machine 140; monitoring the unsafety virtual machine 140, wherein the monitoring includes creating, destroying, or resetting the virtualization service layer associated with the unsafety virtual machine 140 and/or instances of the unsafety virtual machine(s); performing information retransmission among a plurality of unsafety virtual machines 140; and/or providing device virtualization service to implement device sharing for unsafety virtual machines 140, wherein the device virtualization service may represent a service that virtualizes a device in the virtual machine; etc.; or any combinations thereof, but the example embodiments are not limited thereto.

Since the processor resource(s) and/or the memory resource(s) of the unsafety virtual machine 140 may be dynamically scheduled, the operation is more flexible. The virtualization service layer 121 may also provide a rich communication channel for the unsafety virtual machine 140 to frequently transfer a large amount of data between the unsafety virtual machines 140, etc. The device sharing implemented by the unsafety virtual machine 140 may improve a utilization rate of the device.

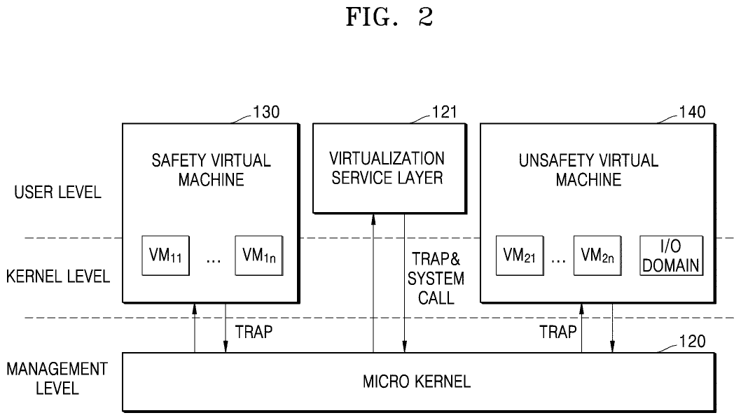

For better understanding of the specific operation of the micro kernel 120 and the virtualization service layer 121, more details will be described with reference to FIG. 2.

FIG. 2 shows a schematic diagram of interaction of an extensible hypervisor according to at least one example embodiment of the inventive concepts. FIG. 2 also illustrates the privilege levels of the micro kernel 120 and the virtualization service layer 121.

As shown in FIG. 2, the micro kernel 120 and the safety virtual machines 130 (e.g., VM11 to VM₁ₙ) and/or the unsafety virtual machines 140 (e.g., VM₂₁ to VM₂ₙ) perform communication through a trap (e.g., a hardware interrupt, an exception, a fault, etc.), and the micro kernel 120 and the virtualization service layer 121 may perform communication through a system call and the trap, but the example embodiments are not limited thereto. The unsafety virtual machine 140 may also include an interface of an input/output domain (I/O Domain) (not shown), and the I/O Domain may represent a virtual machine for providing the device virtualization service, but the example embodiments are not limited thereto.

It can be seen from FIG. 2 that the management of the virtualization service layer 121 by the micro kernel 120 is implemented through the system call and the trap, but is not limited thereto. The management of the safety virtual machine 130 by the micro kernel 120 is implemented by the trap, but is not limited thereto. The micro kernel 120 may also transmit a command of the virtualization service layer 121 for controlling the unsafety virtual machine 140 to the unsafety virtual machine 140. However, the example embodiments are not limited thereto, and the micro kernel 120 may manage the safety virtual machine 130 by other means.

It can also be seen from FIG. 2 that the virtualization service layer 121 may implement controlling the unsafety virtual machine 140 by means of a micro kernel 120. Specifically, the virtualization service layer 121 is further configured to implement controlling the unsafety virtual machine 140 by means of: the trap and the system call between the virtualization service layer 121 and the micro kernel 120, and the trap between the micro kernel 120 and the unsafety virtual machine 140, but the example embodiments are not limited thereto.

In addition, FIG. 2 illustrates a plurality of privilege levels, which include: a user level (e.g., low priority level), a kernel level (e.g., medium priority level), and/or a management level (e.g., high priority level), but the example embodiments are not limited thereto and other privilege levels may be included. The privilege level between two dashed lines in FIG. 2 is the kernel level. According to an order of privilege levels from low to high, there are the user level, the kernel level, and the management level, but is not limited thereto. The user level may provide non-safety-critical service, such as an entertainment service and the like. The virtualization service layer 121 is located at the user level, and the micro kernel 120 is located at the management level, and thus, as mentioned above, the stability of the micro kernel 120, safety virtual machine 130 and/or the embedded system 100, can be increased, improved, and/or ensured. Additionally, the safety virtual machine 130 and/or the unsafety virtual machine 140 may operate in the user level, the kernel level, and/or both the user level and the kernel level (e.g., a first safety virtual machine VM₁₁ may operate in the kernel level and a second safety virtual machine VM_{1N} may operate in the user level, etc.; and a first unsafety virtual machine VM₂₁ may operate in the kernel level and a second unsafety virtual machine VM_{2N} may operate in the user level, etc.) as desired, but the example embodiments are not limited thereto.

Various example embodiments of the inventive concepts describe a hypervisor. During actual usage, the hypervisor may be applied to an embedded system or may be implemented by means of a non-transitory computer-readable storage medium storing computer readable instructions or code (e.g., software). The embedded system according to at least one example embodiment of the inventive concepts may be understood in conjunction with FIG. 3.

As shown in FIG. 3, the embedded system according to at least one example embodiment of the inventive concepts may include: a memory 200 configured to store computer readable (e.g., computer executable, machine readable/executable, etc.) codes or computer readable instructions; and at least one processor (e.g., processor cores, etc.) configured to implement the hypervisor by executing the computer readable codes or instructions stored on the memory 200. The hypervisor implemented by the embedded system can be understood by referring to at least one above example embodiments, and no more descriptions are repeated here.

According to another at least one example embodiment of the inventive concepts, a non-transitory computer-readable storage medium storing the instructions or codes is provided, wherein when the instructions or codes are operated on a system on chip, the system on chip is caused to implement the hypervisor.

Although various example embodiments of the inventive concepts have been specifically shown and described with reference to the example embodiments thereof, those skilled in the art should understand that various changes of the forms and details can be made without departing from the spirit and scope of the inventive concepts as defined by the claims.

What is claimed is:

1. A system-on-chip (SOC) configured to execute an extensible hypervisor, the SOC comprising:
processing circuitry configured to execute the extensible hypervisor, the extensible hypervisor including a micro kernel and a virtualization service layer;
the micro kernel is configured to provide a virtualization environment for at least one first-type virtual machine;
the virtualization service layer is configured to provide a service interface for at least one second-type virtual machine; and
the micro kernel is executed at a first privilege layer, and the virtualization service layer is executed at a second privilege layer.

2. The SOC of claim 1, wherein the micro kernel is further configured to perform at least one of:
perform static assignment of at least one processor resource and/or at least one memory resource for the at least one first-type virtual machine;
provide a communication channel for the at least one first-type virtual machine;
manage the virtualization service layer; and
communicate with at least one of the at least one first-type virtual machine, the at least one second-type virtual machine, and the virtualization service layer.

3. The SOC of claim 2, wherein
the managing of the virtualization service layer includes monitoring the virtualization service layer; and
the monitoring the virtualization service layer includes,
creating a virtual machine instance, destroying the virtual machine instance, or resetting the virtual machine instance.

4. The SOC of claim 2, wherein the communicating with the at least one first-type virtual machine comprises:
performing information forwarding among a plurality of first-type virtual machines.

5. The SOC of claim 2, wherein the micro kernel and the at least one first-type virtual machine and/or the at least one second-type virtual machine perform the communicating through a trap, and the micro kernel and the virtualization service layer perform the communicating through a system call and the trap.

6. The SOC of claim 1, wherein the virtualization service layer is further configured to control at least one of:
performing a dynamic scheduling of at least one processor resource and/or at least one memory resource for the at least one second-type virtual machine;
monitoring the at least one second-type virtual machine, wherein the monitoring comprises creating a second-type virtual machine instance, destroying the second-type virtual machine instance, or resetting the second-type virtual machine instance;
performing information forwarding among a plurality of second-type virtual machines; and
providing a device virtualization service to implement device sharing for the plurality of second-type virtual machines.

7. The SOC of claim 6, wherein the virtualization service layer is further configured to implement controlling of the at least one second-type virtual machine using a trap and a system call between the virtualization service layer and the micro kernel, and the trap between the micro kernel and the at least one second-type virtual machine.

8. An embedded system, comprising:
a memory configured to store computer readable instructions; and
processing circuitry configured to execute the computer readable instructions to implement an extensible hypervisor, the extensible hypervisor including a micro kernel and a virtualization service layer, wherein
the micro kernel is configured to provide a virtualization environment for at least one first-type virtual machine,
the virtualization service layer is configured to provide a service interface for at least one second-type virtual machine, and
the micro kernel is executed at a first privilege layer, and the virtualization service layer is executed at a second privilege layer.

9. A non-transitory computer-readable storage medium storing computer readable instructions, wherein when the computer readable instructions is executed by processing circuitry, the processing circuitry is caused to:
execute an extensible hypervisor, the extensible hypervisor including a micro kernel and a virtualization service layer;
the micro kernel being configured to provide a virtualization environment for at least one first-type virtual machine;
the virtualization service layer being configured to provide a service interface for at least one second-type virtual machine; and
the micro kernel is executed at a first privilege layer, and the virtualization service layer is executed at a second privilege layer.
